(19) United States
(12) Patent Application Publication
(10) Pub. No.: US 2020/0050590 A1
(43) Pub. Date: Feb. 13, 2020

(54) METHOD AND DEVICE FOR OBTAINING A PROOF OF WORK IN A COMPUTER NETWORK

(71) Applicant: Robert Bosch GmbH, Stuttgart (DE)

(72) Inventors: Benjamin Herd, Stuttgart (DE); Nik Scharmann, Bietigheim-Bissingen (DE)

(21) Appl. No.: 16/525,055

(22) Filed: Jul. 29, 2019

(30) Foreign Application Priority Data
Aug. 8, 2018 (DE) 102018213301.8

(51) Int. Cl. G06F 16/182; G06Q 30/08; H04L 9/06

(52) U.S. Cl. CPC G06F 16/1827; H04L 9/0637; G06Q 30/08

(57) ABSTRACT

A method for obtaining a proof of work in a computer network, having the following features:
an allocation problem of a multi-dimensional auction having a predetermined time complexity is set as a function of a computing power of the computer network,
the allocation problem is transmitted to a service user in the computer network and
a solution of the allocation problem found by the service user is checked by computation.

### FIELD OF THE INVENTION

The present invention relates to a method for obtaining a proof of work (PoW) in a computer network. The invention also relates to a corresponding device, a corresponding computer program as well as a corresponding storage medium.

### BACKGROUND INFORMATION

In the field of algorithmic mathematics and information technology, proof of work (computational puzzle, cryptographic puzzle) is understood to be any method which allows a service user to prove that it has furnished substantial computing power. For example, according to the related art, PoWs are used to prevent excessive use of a service or to permit consensus building with respect to a distributed ledger.

For instance, known PoW protocols require the solving of differential equations, the carrying-out of a brute-force attack on weakened cryptographic primitives, the execution of mathematical operations on densely occupied matrices or—as in the case of the cryptocurrency “bitcoin” or other blockchains—the partial inversion of a hash function.

German Patent No. 102017204536 relates to a method for issuing a virtual document with the aid of a first computer system of an issuer. The method includes the creation of the virtual document; calculation of a hash value of the virtual document; transmission of a signed entry request together with the hash value to a blockchain server; reception of the signed entry request by the blockchain server; execution of program instructions of a program module, identified by the signed entry request, by the blockchain server, the execution of the program instructions including checking the signature of the entry request using a public cryptographic key of the issuer registered in the blockchain; and, in the case of a valid signature, in order to issue the virtual document, generation of an additional block of the blockchain, the generated block including an entry with the first hash value assigned to the program module.

### SUMMARY

The present invention provides a method for obtaining a proof of work in a computer network, a corresponding device, a corresponding computer program as well as a corresponding storage medium according to the independent claims.

The approach according to the present invention is based on the recognition that the computing power furnished within the framework of conventional PoW protocols serves no purpose beyond producing the required proof of work.

In contrast, an advantage of the design approach presented here lies in the additional economic utility of the PoW method according to the present invention. In the present case, this involves the offset of supply and demand according to an auction system.

Advantageous further developments of and improvements to the basic idea set forth in the independent claim are made possible by the measures delineated in the dependent claims.

### BRIEF DESCRIPTION OF THE DRAWINGS

FIG. 1 shows the flowchart of a method according to a first specific embodiment.

FIG. 2 shows schematically, a server according to a second specific embodiment.

### DETAILED DESCRIPTION

Complex scenarios necessitate the exchange of bundles of heterogeneous goods and therefore combinational auctions for allocation; commercial goods, which themselves may be characterized by multiple attributes, require multi-attribute auctions that are sometimes also referred to as multivariate auctions. Both combinational and multi-attribute auctions are special variants of multi-dimensional auctions, whose allocation problem belongs to the NP complexity class. Optimal allocations are therefore costly to calculate in both cases, while the verification of a given allocation in both cases is possible in polynomial time and thus is able to be calculated efficiently. The above-indicated proof of work mechanisms used in blockchain systems are provided with a similar expenditure asymmetry. For instance, the PoW method used in the case of the cryptocurrency bitcoin is based on a SHA-2 one-way function, but serves no other economic use.

The present method not only utilizes the expenditure asymmetry, as in the case of a conventional PoW mechanism, to ensure the consistency of the system, but also at the same time solves an auction problem within the foreseeable “economy of things” (EoT). Like in the case of conventional approaches, to that end, a function is needed which maps the computing power of the network and complexity of the pending auction problem, in order to achieve a desired time complexity. The PoW algorithm used in the case of blockchains takes this desired “block confirmation time” (BCT) into account by adjusting the degree of difficulty of the hash-value target.

In the method according to the present invention, the following relationship holds true for target runtime complexity t

t=f(K, O, P),

where K denotes the complexity of the original allocation problem, O denotes the computing power of the ledger and P denotes the padding explained below. K and O are not able to be influenced directly. In order to achieve desired runtime complexity t, according to the invention, aforesaid value P is introduced. The function of P will now be explained on the basis of two cases.

If K and O assume values which are too high and the complexity of the original auction problem therefore turns out to be too low, the bundles in the order book are padded with additional, so to speak, “dummy” goods. In the case of a multi-attribute auction, the commercial goods in the order book are provided in corresponding manner with additional “dummy” attributes in the above sense. The measure in question is repeated until the total complexity of the allocation problem of the auction reaches the predetermined target value.

On the other hand, if K and O assume values which are too low and the complexity of the original auction problem therefore exceeds the target value, the number of combination possibilities of the bundles potentially occurring in the combinational auction is reduced to begin with by the definition of more suitable bundles. This corresponds to a “granularization” of the bundles, that is, their pre-division into classes. This division into classes is also adjusted here, until the total complexity of the allocation problem of the respective auction reaches the predetermined target value. As an alternative measure for making the allocation problem easier, the number of bids and asks to be brought into agreement is reduced by the selection of random samples (sampling).

As an alternative to the measures described above, an approximative approach may be useful, which may be parameterized on a continuous scale in terms of its approximation to the theoretically optimal allocation result. Basically, this approach would supply approximative results, whose accuracy would be quantifiable precisely with statistical methods, however.

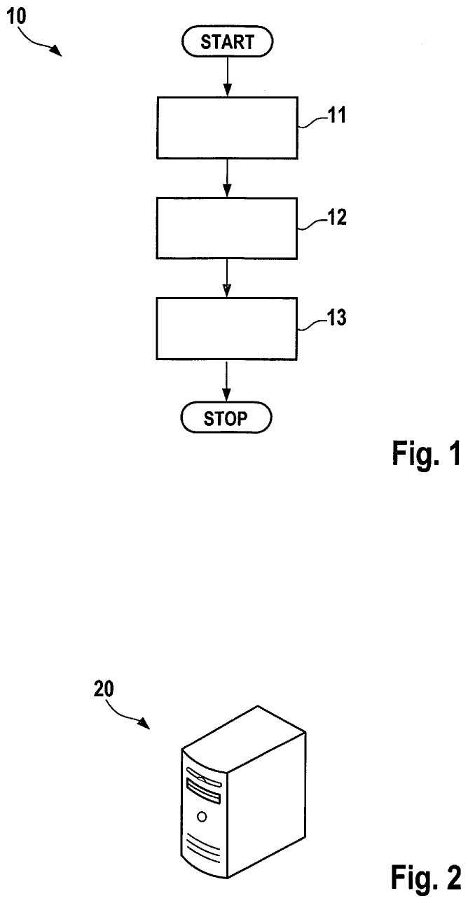

FIG. 1 illustrates the basic steps of resultant method (10) in their entirety. After the described determination of the allocation problem (process 11), it is transmitted to a service user (process 12) and the solution found by the latter is ultimately checked by computation (process 13).

This method (10) may be implemented in software or hardware, for example, or in a mixed form of software and hardware, e.g., in a server (20), as the schematic representation in FIG. 2 illustrates.

What is claimed is:

1. A method for obtaining a proof of work in a computer network, comprising:
setting an allocation problem of a multi-dimensional auction as a function of a computing power of the computer network, the allocation problem having a predetermined time complexity;
transmitting the allocation problem to a service user in the computer network; and
checking by computation a solution of the allocation problem found by the service user.

2. The method as recited in claim 1, wherein the auction is combinational.

3. The method as recited in claim 2, wherein the allocation problem is one of:
made more difficult as needed as a function of the predetermined time complexity, by adding bundles of goods to an order book of the auction, and
simplified by combining the bundles of goods.

4. The method as recited in claim 2, wherein the allocation problem is simplified as needed as a function of the predetermined time complexity, by combining bundles of goods in an order book of the auction to form classes.

5. The method as recited in claim 1, wherein:
the auction is multivariate, and
the allocation problem is made more difficult as needed as a function of the predetermined time complexity, by augmenting commercial goods in an order book of the auction, with attributes.

6. The method as recited in claim 1, wherein the allocation problem is simplified as needed as a function of the predetermined time complexity, by reducing supplies and demands at random.

7. The method as recited in claim 1, wherein the proof of work is used to build consensus in a distributed ledger.

8. A computer program equipped to carry out a method for obtaining a proof of work in a computer network, the method comprising:
setting an allocation problem of a multi-dimensional auction as a function of a computing power of the computer network, the allocation problem having a predetermined time complexity;
transmitting the allocation problem to a service user in the computer network; and
checking by computation a solution of the allocation problem found by the service user.

9. A machine-readable storage medium on which a computer program is stored, the computer program being equipped to carry out a method for obtaining a proof of work in a computer network, the method comprising:
setting an allocation problem of a multi-dimensional auction as a function of a computing power of the computer network, the allocation problem having a predetermined time complexity;
transmitting the allocation problem to a service user in the computer network; and
checking by computation a solution of the allocation problem found by the service user.

10. A device equipped to carry out a method for obtaining a proof of work in a computer network, comprising:
an arrangement for setting an allocation problem of a multi-dimensional auction as a function of a computing power of the computer network, the allocation problem having a predetermined time complexity;
an arrangement for transmitting the allocation problem to a service user in the computer network; and
an arrangement for checking by computation a solution of the allocation problem found by the service user.
